(19) United States
(12) Patent Application Publication
(10) Pub. No.: US 2009/0219370 A1
(43) Pub. Date: Sep. 3, 2009

(54) INK JET RECORDING APPARATUS

(75) Inventors: Atsushi Kubota, Sunto-gun (JP); Masashi Hiroki, Yokohama-shi (JP); Satoshi Kaiho, Yokohama-shi (JP); Takashi Kado, Izunokuni-shi (JP); Kazuhiko Ohtsu, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/390,553

(22) Filed: Feb. 23, 2009

Related U.S. Application Data
(60) Provisional application No. 61/032,374, filed on Feb. 28, 2008.

(51) Int. Cl. B41J 2/01

(52) U.S. Cl. 347/104

(57) ABSTRACT

An ink jet recording apparatus including an ink jet head in which a plurality of nozzles are arranged, a sub-scan driving unit which carries a recording medium to be formed with an image, a suction unit which sucks the recording medium on the sub-scan driving unit, and a heating unit which is disposed with respect to at least one place of the sub-scan driving unit in a direction perpendicular to a carrying direction of the recording medium with a gap therebetween.

### CROSS-REFERENCE TO RELATED APPLICATION

This application claims the benefit of U.S. Provisional Application No. 61/032,374, filed Feb. 28, 2008.

### TECHNICAL FIELD

The present invention relates to an ink jet recording apparatus which ejects aqueous ink from an ink jet head to form an image on a paper.

### BACKGROUND

An ink jet recording apparatus can record an image with high accuracy at high speed. Further, the ink jet recording apparatus adopts a non-impact system, so that noises are little. Moreover, the ink jet recording apparatus has an advantage that a color image is easily recorded by using multicolored inks. Therefore, the ink jet recording apparatus becomes common practice for home or business use.

However, in the ink jet recording apparatus, a cellulose fiber is swollen or untied especially in a plain paper by moisture in the inks, a phenomenon referred to as a rippling cockling occurs in the paper in a cycle of several to tens mm. For this reason, there is the defect that it is difficult for users to handle the paper after being printed.

In JP-A-10-217572, a configuration is disclosed in which while an ink jet head and a recording sheet are separated from each other, in a recording area where an ink is applied on the recording sheet, the rear surface of the recording sheet is supported by a mesh member having a heater which is disposed at an opposite side to the ink jet head. According to the configuration of JP-A-10-217572, a heating effect is sufficiently exhibited even though the recording sheet does not come in contact with the heater over the entire surface thereof, and further it is possible to always remove vapor which is evaporated from the rear surface of the recording sheet from the recording area to the outside. With the configuration of JP-A-10-217572, a difference between degrees of dryness on both sides of the recording sheet is reduced, and thus a bending of the recording sheet is significantly reduced or removed.

However, in the configuration of JP-A-10-217572, even though the recording sheet can be dried, since correction is not performed, curl and cockling cannot be completely corrected.

An object of the present invention is to provide an ink jet recording apparatus, which can efficiently dry a paper on which an image is formed by using ink.

### SUMMARY

According to one aspect of the present invention, there is provided an ink jet recording apparatus including: an ink jet head in which a plurality of nozzles is arranged; a sub-scan driving unit which carries a recording medium to be formed with an image; a suction unit which sucks the recording medium on the sub-scan driving unit; and a heating unit which is disposed with respect to at least one place of the sub-scan driving unit in a direction perpendicular to a carrying direction of the recording medium with a gap therebetween.

### DESCRIPTION OF THE DRAWINGS

FIG. 1 is a cross-sectional view illustrating an ink jet recording apparatus viewed from a horizontal direction of a first embodiment.

FIG. 2 is a top view illustrating an ink jet head and a heat-fixing device of the first embodiment.

FIG. 3 is a cross-sectional view illustrating the heat-fixing device viewed from a horizontal direction of the first embodiment.

FIG. 4 is an enlarged top view illustrating a carrying belt of the first embodiment.

FIG. 5 is a top view illustrating a modified example of the heat-fixing device of the first embodiment.

FIG. 6 is a cross-sectional view illustrating a modified example of the heat-fixing device viewed from a horizontal direction of the first embodiment.

FIG. 7 is a top view illustrating another modified example of the heat-fixing device of the first embodiment.

FIG. 8 is a cross-sectional view illustrating an ink jet recording apparatus viewed from a horizontal direction of a second embodiment.

FIG. 9 is a cross-sectional view illustrating a heat-fixing device viewed from a horizontal direction of the second embodiment.

FIG. 10 is a top view illustrating the heat-fixing device of the second embodiment.

FIG. 11 is a top view illustrating a modified example of the heat-fixing device of the second embodiment.

FIG. 12 is a top view illustrating an ink jet head and a heat-fixing device of a third embodiment.

FIG. 13 is a top view illustrating a modified example of the ink jet head and the heat-fixing device of the third embodiment.

FIG. 14 is a block diagram illustrating a control system of the ink jet recording apparatus of the first embodiment.

### DETAILED DESCRIPTION

Hereinafter, embodiments will be described.

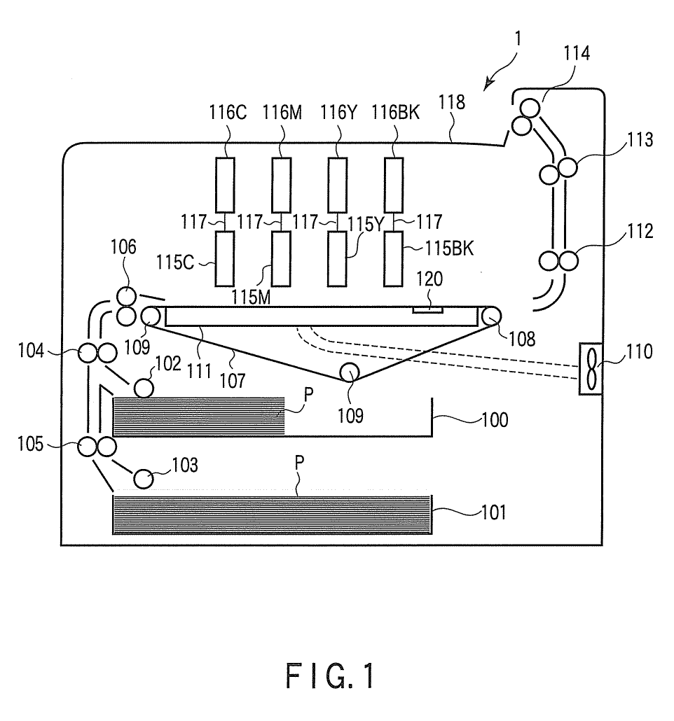

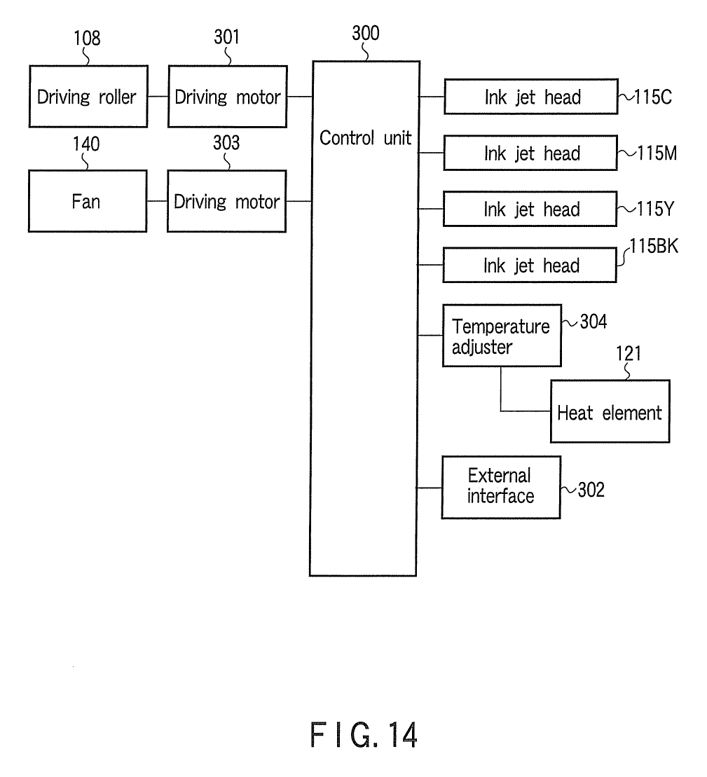

FIG. 1 is a cross-sectional view illustrating an ink jet recording apparatus 1 viewed from a horizontal direction of a first embodiment. FIG. 14 is a block diagram illustrating a control system of the ink jet recording apparatus 1 of the first embodiment.

A first paper cassette 100 and a second paper cassette 101 contain the recording mediums p which are different in size, respectively. A first paper feeding roller 102 withdraws the recording medium p corresponding to a selected size from the first paper cassette 100 to be carried to a pair of first carrying rollers 104 and a pair of resist rollers 106. Similarly, a second paper feeding roller 103 withdraws the recording medium p corresponding to a selected size of the recording medium from the second paper cassette 101 to be carried to a pair of second carrying rollers 105 and the pair of resist rollers 106.

A carrying belt 107 is applied with tension by a driving roller 108 and two driven rollers 109. In a surface of the carrying belt 107, holes are made at a predetermined interval. In addition, in the inside of the carrying belt 107, a negative pressure chamber 111 is provided so as to be connected to a fan 110 in order to suck the recording medium p to the carrying belt 107.

The driving roller 108 drives the carrying belt 107 so as to carry the recording medium p from an upstream side where the pair of the resist rollers 106 is formed as a paper feeding unit to a downstream side where a pair of first carrying rollers 112, a pair of second carrying rollers 113, and a pair of third carrying rollers 114 are formed as the paper feeding unit. A carrying direction of the recording medium p is a sub-scan direction when it is viewed from a recording operation in the ink jet recording apparatus 1.

In the downstream side of the carrying direction of the recording medium p on the carrying belt 107, a heat-fixing device 120 which heats the recording medium p where the image is formed is disposed. The heat-fixing device 120 will be described in detail later.

Above the carrying belt 107, ink jet heads which eject inks to the recording medium according to image data are disposed on four lines. Specifically, from the upstream side, an ink jet head 115C which ejects a cyan (C) ink, an ink jet head 115M which ejects a magenta (M) ink, an ink jet head 115Y which ejects a yellow (Y) ink, and an ink jet head 115Bk which ejects a black (Bk) ink are disposed in this order.

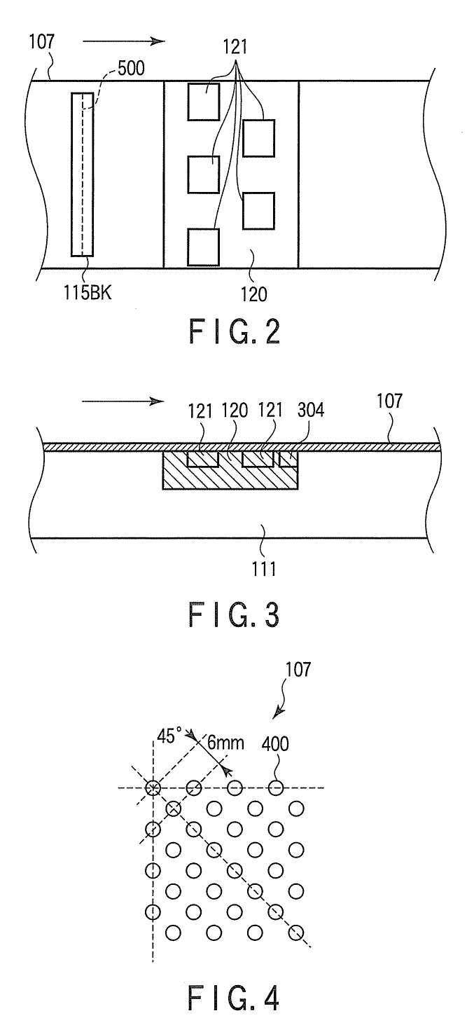

In the ink jet heads 115C, 115M, 115Y, and 115Bk, nozzles 500 which eject ink are disposed at a predetermined resolution along a width direction of the recording medium p, respectively (refer to FIG. 2). That is, the ink jet heads 115C, 115M, 115Y, and 115Bk are line type print heads in which plural nozzles 500 are arranged on a line. In the ink jet heads 115C, 115M, 115Y, and 115Bk, the nozzles 500 are arranged in a direction perpendicular to the carrying direction of the recording medium p by the carrying belt 107. The nozzles 500 are arranged so as to be positioned with a defined distance with respect to the recording medium p which is located on the carrying belt 107. Here, an alignment direction of the nozzles 500 is a main scan direction.

The ink jet recording apparatus 1 of the first embodiment is provided with the line type ink jet heads 115C, 115M, 115Y, and 115Bk on the carrying belt 107 which carries the recording medium p. The ink jet heads 115C, 115M, 115Y, and 115Bk perform the recording operation on the recording medium p on the basis of image signals inputted. If the ink jet heads 115C, 115M, 115Y, and 115Bk are a line type, any driving scheme thereof is sufficient. That is, in the ink jet heads 115C, 115M, 115Y, and 115Bk, a scheme using thermoelectric conversion elements, a scheme using electrostrictive conversion elements, or other schemes such as an ink ejecting scheme are applicable.

The carrying belt 107 and the driving roller 108 are sub-scan driving units which relatively move the recording medium p and the ink jet heads 115C, 115M, 115Y, and 115Bk in the sub-scan direction perpendicular to the alignment direction of the nozzles 500. That is, the carrying belt 107 and the driving roller 108 perform a sub-scan driving process in which the recording medium p and the ink jet heads 115C, 115M, 115Y, and 115Bk are relatively moved in the sub-scan direction perpendicular to the alignment direction of the nozzles 500.

That is, the ink jet recording apparatus 1 of the first embodiment performs the recording operation on the recording medium p in the line scheme (one path recording scheme). A control unit 300 controls the ink jet heads 115C, 115M, 115Y, and 115Bk to be driven on the basis of the image signals to perform a main scan driving process in which ink droplets are selectively ejected from the nozzles 500. In addition, the control unit 300 drives the driving roller 108 by a driving motor 301. The control unit 300 performs the sub-scan driving process in which the ink jet heads 115C, 115M, 115Y, and 115Bk and the recording medium p are relatively moved in the sub-scan direction. The recording operation is performed by the main scan driving process and the sub-scan driving process.

Further, in the ink jet heads 115C, 115M, 115Y, and 115Bk, a cyan (C) ink cartridge 116C, a magenta (M) ink cartridge 116M, a yellow (Y) ink cartridge 116Y, and a black (Bk) ink cartridge 116Bk in which respective colors are filled are provided. The ink jet head 115C and the ink cartridge 116C, the ink jet head 115M and the ink cartridge 116M, the ink jet head 115Y and the ink cartridge 116Y, and the ink jet head 115Bk and the ink cartridge 116Bk are connected through tubes 117, respectively.

Here, an example of composition in aqueous inks of black, yellow, cyan, and magenta will be shown.

Black
Self-dispersed carbon black dispersion liquid
(Made by Cabot Specialty Chemicals Ink)

| | | |
|---|---|---|
| (Carbon black solid content concentration) | 8.0 | wt % |
| Glycerin | 30.0 | wt % |
| Ethylene glycol mono butyl ether | 0.5 | wt % |
| Surfynol 465 | 1.0 | wt % |
| Proxel XL-2 (S) | 0.2 | wt % |
| Ion-exchange water remaining amount | (60.3 | wt %) |

Yellow
Self-dispersion yellow dispersion liquid
(Made by Cabot Specialty Chemicals Ink)

| | | |
|---|---|---|
| (Yellow pigment solid content concentration) | 6.0 | wt % |
| Glycerin | 45.0 | wt % |
| Ethylene glycol mono butyl ether | 5.0 | wt % |
| Surfynol 465 | 1.0 | wt % |
| Proxel XL-2 (S) | 0.2 | wt % |
| Ion-exchange water remaining amount | (42.8 | wt %) |

Magenta
Polymer dispersant dispersed magenta dispersion liquid
(Made by Fuji Shikiso)

| | | |
|---|---|---|
| (Magenta pigment solid content concentration) | 6.0 | wt % |
| Glycerin | 45.0 | wt % |
| Diethylene glycol mono butyl ether | 5.0 | wt % |
| Surfynol 465 | 1.0 | wt % |
| Proxel XL-2 (S) | 0.2 | wt % |
| Ion-exchange water remaining amount | (42.8 | wt %) |

Cyan
Polymer dispersant dispersed cyan dispersion liquid
(Made by Fuji Shikiso)

| | | |
|---|---|---|
| (Cyan pigment solid content concentration) | 6.0 | wt % |
| Glycerin | 45.0 | wt % |
| Triethylene glycol mono butyl ether | 5.0 | wt % |
| Surfynol 465 | 1.0 | wt % |
| Proxel XL-2 (S) | 0.2 | wt % |
| Ion-exchange water remaining amount | (57.2 | wt %) |

The above-mentioned ink includes water of 60.3 wt % as a maximum value or 42.8 wt % as a minimum value. Until the image is completely formed, it is necessary to dry the recording medium by evaporating the moisture down to an amount of moisture which is generally absorbed into the recording medium.

Next, an image formation by the ink jet recording apparatus 1 of the first embodiment will be described.

Firstly, when the control unit 300 obtains image data to be printed on the recording medium p via an external interface 302, an image process begins. The control unit 300 transfers the image data subjected to the image process to the ink jet heads 115C, 115M, 115Y, and 115Bk. Here, the ink jet heads 115C, 115M, 115Y, and 115Bk are connected with respective colors of the ink cartridges 116C, 116M, 116Y, and 116Bk through tubes 117, respectively. In the ink jet heads 115C, 115M, 115Y, and 115Bk, proper inks are supplied on the basis of the image data.

The first paper feeding roller 102 or the second paper feeding roller 103 withdraws the recording medium p corresponding to the selected size one by one from the first paper cassette 100 or the second paper cassette 101. The recording medium p is carried to the pair of the first carrying rollers 104 or the pair of the second carrying rollers 105 and the pair of the resist rollers 106.

The pair of the resist rollers 106 corrects a skew of the recording medium p and begins to carry the recording medium at a predetermined timing. By reducing pressure in the negative pressure chamber 111, air is drawn through holes of the carrying belt 107. The recording medium p which is sucked on the carrying belt 107 is carried to a position facing the ink jet heads 115C, 115M, 115Y, and 115Bk. Therefore, a distance between the ink jet heads 115C, 115M, 115Y, and 115Bk and the recording medium p is maintained at a constant interval, for example, 0.5 to 2.0 mm. The control unit 300 is synchronized with the timing when the recording medium p is carried from the pair of the resist rollers 106, and ejects the respective colors from the ink jet heads 115C, 115M, 115Y, and 115Bk. Since the nozzles 500 of the ink jet heads 115C, 115M, 115Y, and 115Bk are arranged along the width direction of the recording medium p, when the recording medium p is carried, a full color image is formed on the entire surface of the recording medium p.

After the Bk ink ejected from the ink jet head 115Bk is finally landed on the recording medium p and a predetermined time lapses, the carrying belt 107 carries the recording medium p to the heat-fixing device 120. The heat-fixing device 120 is embedded in the negative pressure chamber 111 at a position on the downstream of the ink jet head 115Bk along the carrying direction of the recording medium p. The heat-fixing device 120 is a mechanism for evaporating the moisture which is included in the recording medium p in the middle of being passed. The recording medium p dried by the head-fixing device 120 is discharged to a discharge tray 118 by the pair of the first carrying rollers 112, the pair of the second carrying rollers 113, and the pair of the third carrying rollers 114.

Next, a configuration of the heat-fixing device 120 of the first embodiment will be described. FIG. 2 is a top view illustrating an ink jet head 115C and a heat-fixing device 120 of the first embodiment. FIG. 3 is a cross-sectional view illustrating the heat-fixing device 120 viewed from a horizontal direction of the first embodiment. FIG. 4 is an enlarged top view illustrating a carrying belt 107 which comes in contact with the heat-fixing device 120 of the first embodiment. Here, the configuration of the nozzles 500 which are arranged in the ink jet head 115C is shown in FIG. 2, and the ink jet head 115M, the ink jet head 115Y, and the ink jet head 115Bk are also the same configuration as that of the ink jet head 115C.

As shown in FIG. 3, the heat-fixing device 120 is embedded in the negative pressure chamber 111. An arrow shows the carrying direction of the recording medium p, and the same is true in FIG. 2 or later. The carrying belt 107 carries the recording medium p which is sucked on the heat-fixing device 120 by the negative pressure chamber 111. An image forming surface of the recording medium p is placed to be faced upward, and the carrying belt 107 carries the recording medium p such that the image forming surface comes into contact with an external air.

As shown in FIG. 4, plural holes 400 are made in the carrying belt 107. The holes 400 are provided, for example, at a 6 mm interval so as to be inclined with 45 degree with respect to the sub-scan direction. Therefore, the negative pressure chamber 111 can suck the recording medium p on the carrying belt 107.

The heat-fixing device 120 includes plural heat elements 121 having a rectangular shape. Here, the heat-fixing device 120 which includes five heat elements 121 will be described. The carrying belt 107 on the heat-fixing device 120 is maintained by the heat elements 121 such that a surface temperature thereof becomes 60 to 70° C. The control unit 300 controls the temperature of the plural heat elements 121 by a temperature adjuster 304. The temperature adjuster 304 adjusts the temperature of the carrying belt 107 which is provided on an arbitrary position of the heat-fixing device 120. The heat-fixing device 120 includes a rubber heater. Here, even though the rubber heater is described as the heat element 121, the heater is not limited thereto as long as that can be embedded in the negative pressure chamber 111.

In the heat-fixing device 120, the plural heat elements 121 are disposed such that the plural heat elements 121 are differently disposed from each other with respect to the carrying direction of the recording medium p, so that the plural heat elements 121 are disposed in parallel to the sub-scan direction by shifting their disposed axes. In addition, the plural heat elements 121 are embedded in the negative pressure chamber 111 so as to come into contact with the carrying belt 107. The plural heat elements 121 are disposed such that at least one of the plural heat elements 121 faces the recording medium p in the width direction (main scan direction) while the carrying belt 107 carries the recording medium p on the heat-fixing device 120. When viewed from the main scan direction, the plural heat elements 121 may be disposed so as to be overlapped. Therefore, the heat-fixing device 120 can heat the recording medium p over the entire surface thereof.

In addition, since the plural heat elements 121 are differently disposed from each other, at least a portion where the heat element 121 is not disposed along the main scan direction exists at any position on the carrying belt 107. Therefore, even though on the heat-fixing device 120, the carrying belt 107 can always carry the recording medium p with being sucked through the plural holes 400 which are provided in the carrying belt 107 by the negative pressure chamber 111.

The heat-fixing device 120 of the first embodiment described above can heat the image-formed recording medium p, which contains the moisture in the ink, with being always sucked on the carrying belt 107. The heat-fixing device 120 can evaporate the moisture while the cockling in the recording medium p is corrected to be flattened. For this reason, there is no cockling in the recording medium p which passes over the heat-fixing device 120, and the ink formed as the image is also dried.

The heat-fixing device 120 heats the recording medium p from an opposite surface of the image forming surface. In the recording medium p on which the image is formed, the much moisture is unevenly distributed on the image forming surface. If the heat-fixing device 120 heats the recording medium p from the opposite surface of the image forming surface, the generated vapor is not through the internal of the recording medium p but directly diffused to the external from the image forming surface. Therefore, the recording medium p is not swollen by the generated vapor.

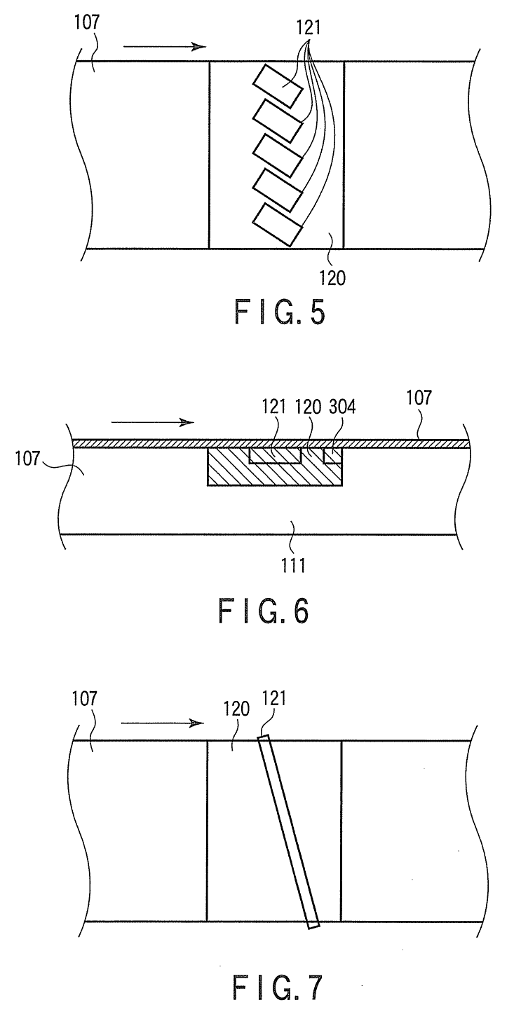

Next, a modified example of the heat-fixing device 120 of the first embodiment will be described. FIG. 5 is a top view illustrating the heat-fixing device 120. FIG. 6 is a cross-sectional view illustrating the heat-fixing device 120 viewed from a horizontal direction. The same is true in the above-mentioned description other than the alignment of the heat elements 121.

The heat-fixing device 120 includes the plural heat elements 121 having a rectangular shape. Here, the heat-fixing device 120 which includes five heat elements 121 will be described. The plural heat elements 121 are disposed so as to be constantly inclined with respect to the carrying direction of the recording medium p. The plural heat elements 121 have a positional relation in which they are shifted on the same axis along the main scan direction. The plural heat elements 121 are also provided on both ends of the main scan direction of the carrying belt 107. In addition, while the carrying belt 107 carries the recording medium p on the heat-fixing device 120, the plural heat elements 121 are disposed such that at least one of the plural heat elements 121 faces the recording medium p in the width direction (main scan direction). When viewed from the main scan direction, the plural heat elements 121 may be disposed so as to be overlapped. Therefore, the heat-fixing device 120 can heat the recording medium p over the entire surface thereof.

In addition, since the plural heat elements 121 are disposed so as not to come into contact with each other at a predetermined interval, at least a portion where the heat element 121 is not disposed along the main scan direction exists at any position on the carrying belt 107. Therefore, even though on the heat-fixing device 120, the carrying belt 107 can always carry the recording medium p with being sucked through the plural holes 400 which are provided in the carrying belt 107 by the negative pressure chamber 111.

Even though the heat elements 121 are disposed as shown in FIG. 5 and FIG. 6, the same effects can be obtained as that of the configuration where the heat elements 121 are disposed as shown in FIG. 2 and FIG. 3.

FIG. 7 is a top view illustrating another modified example of the heat-fixing device 120 of the first embodiment. The same is true in the above-mentioned description other than the alignment of the heat elements 121.

The heat-fixing device 120 includes one heat element 121 having a rectangular shape. The heat element 121 is disposed along the main scan direction so as to be constantly inclined with respect to the carrying direction of the recording medium p. Both ends of the heat element 121 are provided on both ends of the main scan direction of the carrying belt 107. While the carrying belt 107 carries the recording medium p on the heat-fixing device 120, the heat-fixing device 120 can heat the recording medium p over the entire surface thereof.

In addition, since the heat element 121 is disposed so as to be constantly inclined with respect to the carrying direction, at least a portion where the heat element 121 is not disposed along the main scan direction exists at any position on the carrying belt 107. Therefore, even on the heat-fixing device 120, the carrying belt 107 can always carry the recording medium p with being sucked through the plural holes 400 which are provided in the carrying belt 107 by the negative pressure chamber 111.

Even though the heat elements 121 are disposed as shown in FIG. 7, the same effects can be obtained as that of the configuration where the heat elements 121 are disposed as shown in FIG. 2 and FIG. 3.

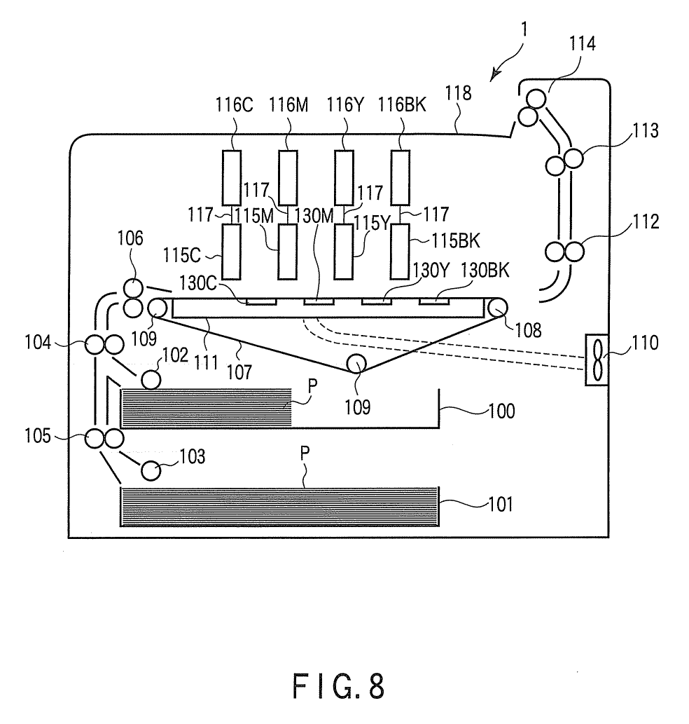

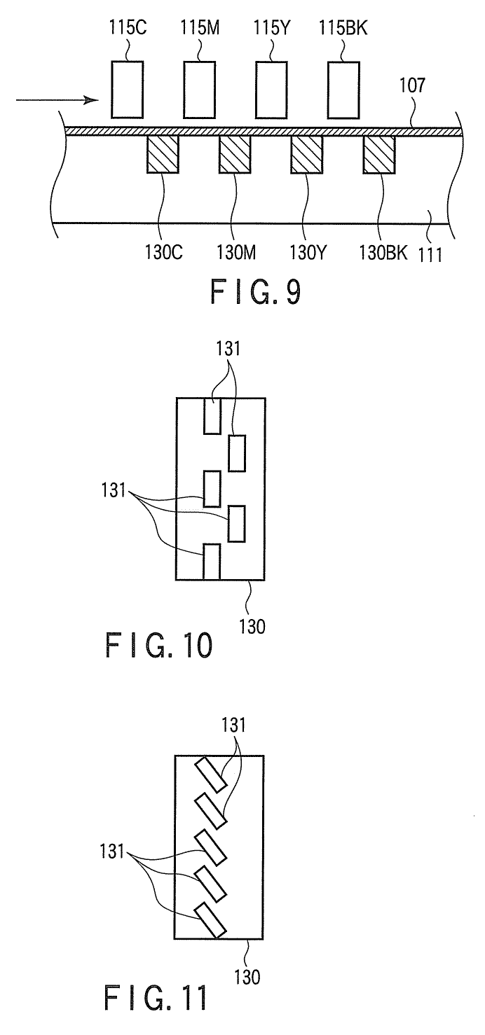

Next, a second embodiment will be described. FIG. 8 is a cross-sectional view illustrating the ink jet recording apparatus 1 viewed from a horizontal direction of a second embodiment. FIG. 9 is a cross-sectional view illustrating the heat-fixing devices 130C, 130M, 130Y, and 130Bk viewed from a horizontal direction of the second embodiment.

In the second embodiment, configurations other than the heat-fixing device 130C, 130M, 130Y, and 130Bk which are provided instead of the heat-fixing device 120 of the first embodiment shown in FIG. 1 are the same as those of the ink jet recording apparatus 1 shown in FIG. 1. In addition, the recording operation by the ink jet recording apparatus 1 is also the same as that of the first embodiment.

In the heat-fixing apparatus 130C, the negative pressure chamber 111 is embedded in a position between the ink jet head 115C and the ink jet head 115M along the carrying direction of the recording medium p. The heat-fixing device 130M is embedded in the negative pressure chamber 111 in a position between the ink jet head 115M and the ink jet head 115Y along the carrying direction of the recording medium p. The heat-fixing device 130Y is embedded in the negative pressure chamber 111 in a position between the ink jet head 115Y and the ink jet head 115Bk along the carrying direction of the recording medium p. The heat-fixing device 130Bk is embedded in the negative pressure chamber 111 in a position on the downstream of the ink jet head 115Bk along the carrying direction of the recording medium p.

FIG. 10 is a top view illustrating the heat-fixing device 130C of the second embodiment. Here, a configuration of the heat-fixing device 130C will be described, and configurations of the heat-fixing device 130M, the heat-fixing device 130Y, and the heat-fixing device 130Bk are also the same as that of the heat-fixing device 130C.

The heat-fixing device 130M includes the plural heat elements 131 having a rectangular shape. Here, the heat-fixing device 130M which includes five heat elements 131 will be described. In the heat-fixing device 120, the plural heat elements 121 are disposed such that the plural heat elements 121 are differently disposed from each other with respect to the carrying direction of the recording medium p, so that the plural heat elements 131 are disposed in parallel to the sub-scan direction by shifting their disposed axes. The plural heat elements 121 are controlled by the temperature adjuster 304 which is provided on arbitrary position of the heat-fixing device 120 such that the surface temperature of the carrying belt 107 on the heat-fixing device 120 is maintained to become 60 to 70° C.

Similar to the disposition of the plural heat elements 121 shown in FIG. 5, the plural heat elements 131 are disposed such that at least one of the plural heat elements 131 faces the recording medium p in the width direction (main scan direction) while the carrying belt 107 carries the recording medium p on the heat-fixing device 120. Therefore, the heat-fixing device 130 can heat the recording medium p over the entire surface thereof. Since the plural heat elements 121 are differently disposed from each other, even on the heat-fixing device 130, the carrying belt 107 can carry the recording medium p with being always sucked through the plural holes 400 which are provided in the carrying belt 107 by the negative pressure chamber 111.

The heat-fixing apparatus 130C of the second embodiment described above can heat the image-formed recording medium p, which contains the moisture in the ink, with being always sucked on the carrying belt 107. In addition, the heat-fixing device 130C heats the recording medium p on which the image is formed with the C ink immediately after the C ink ejected from the ink jet head 115C is landed on the recording medium p.

Similarly, the heat-fixing device 130M heats the recording medium p on which the image is formed with the M ink immediately after the M ink ejected from the ink jet head 115M is landed on the recording medium p. The heat-fixing device 130Y heats the recording medium p on which the image is formed with the Y ink immediately after the Y ink ejected from the ink jet head 115Y is landed on the recording medium p. The heat-fixing device 130Bk heats the recording medium p on which the image is formed with the Bk ink immediately after the Bk ink ejected from the ink jet head 115Bk is landed on the recording medium p.

In the second embodiment, since the heat-fixing device 130C, the heat-fixing device 130M, the heat-fixing device 130Y, and the heat-fixing device 130Bk can dry the recording medium p immediately after the image is formed by the inks ejected from the ink jet heads 115C, 115M, 115Y, and 115Bk, the moisture can be effectively evaporated in a state where the cockling in the recording medium p is corrected to be flattened. For this reason, there is no cockling in the recording medium p which is finally passed over the heat-fixing device 130Bk, and the ink formed as the image is also dried.

An effect of heating the recording medium p from the opposite surface of the image forming surface by the heat-fixing device 130C is the same as the effect described in the first embodiment.

Next, a modified example of the heat-fixing device 130C of the second embodiment will be described. FIG. 11 is a top view illustrating the heat-fixing device 130C. Here, a configuration of the heat-fixing device 130C will be described, and configurations of the heat-fixing device 130M, the heat-fixing device 130Y, the heat-fixing device 130Bk are also the same as that of the heat-fixing device 130C.

The heat-fixing device 130C includes plural heat elements 131 having a rectangular shape. The plural heat elements 131 have the same alignment as that of the plural heat elements 121 described in FIG. 5, and constantly incline with respect to the carrying direction of the recording medium p. Therefore, the heat-fixing device 130C heats the recording medium p over the entire surface on which the image is formed with the C ink immediately after the C ink ejected from the ink jet head 115C is landed on the recording medium p.

Even though the heat elements 131 are disposed as shown in FIG. 11, the same effects can be obtained as that of the configuration where the heat elements 131 are disposed as shown in FIG. 10.

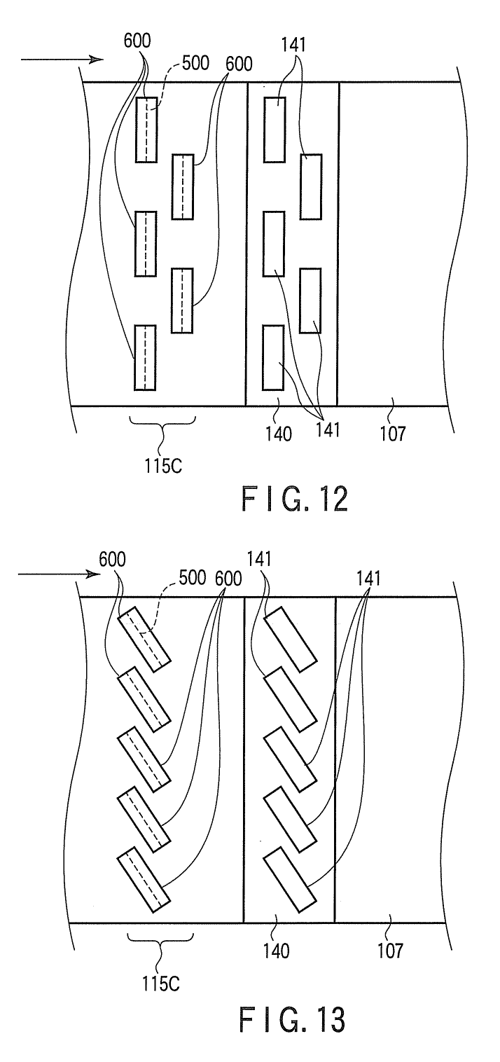

Next, a third embodiment will be described. FIG. 12 is a top view illustrating the ink jet head 115C and a heat-fixing device 140 of a third embodiment.

In the third embodiment, other configurations except for the heat-fixing device 140 and the ink jet heads 115C, 115M, 115Y, and 115Bk which are provided on the same position instead of the heat-fixing device 120 of the first embodiment shown in FIG. 1 are the same as those of the ink jet recording apparatus 1 shown in FIG. 1. In addition, the recording operation by the ink jet recording apparatus 1 is also the same as that of the first embodiment. Here, the configuration of the ink jet head 115C is shown in FIG. 12, and the ink jet head 115M, the ink jet head 115Y, and the ink jet head 115Bk are also the same configuration as that of the ink jet head 115C.

As shown in FIG. 12, in the ink jet head 115C, plural short heads 600 are arranged in parallel. In general, as the ink jet head becomes longer, yield thereof is worsened and the cost is increased. In the ink jet head 115C of the third embodiment, the plural short heads 600 are disposed so that the lengthening is implemented. Here, the ink jet head 115C which includes five heads 600 will be described.

In the ink jet head 115C, the plural heads 600 are disposed such that the plural heads are differently disposed from each other with respect to the carrying direction of the recording medium p, so that the plural heads 600 are disposed in parallel to the sub-scan direction by shifting their disposed axes. The nozzles 500 of the head 600 which is included in the ink jet head 115C are arranged in the width direction (a direction perpendicular to the carrying direction of the recording medium p) of the recording medium p.

In addition, in the heat-fixing device 140, the plural heat elements 141 are disposed such that the plural heat elements 141 are differently disposed from each other with respect to the carrying direction of the recording medium p, so that the plural heat elements 141 are disposed in parallel to the sub-scan direction by shifting their disposed axes. Here, the number of the plural heat elements 141 is the same as that of the plural heads 600 which are included in the ink jet head 115C. Therefore, the number of the plural heat elements 141 is five.

The plural heat elements 141 are provided on a position facing the heads 600 which are included in the ink jet head 115C along the sub-scan direction. All relative distances along the sub-scan direction between the heat elements 141 and the heads 600, which are in facing relation therebetween, are constant. That is, if the alignments of the nozzles 500 of the heads 600 which are included in the ink jet head 115C are shifted along the sub-scan direction, the alignments are included in the alignments of the plural heat elements 141. Therefore, the heat-fixing device 140 can heat an exact portion of the recording medium p on which the image is formed.

In addition, since the plural heat elements 141 are differently disposed from each other, even on the heat-fixing device 140, the carrying belt 107 can carry the recording medium p with being always sucked through the plural holes 400 which are provided in the carrying belt 107 by the negative pressure chamber 111. The heat-fixing device 140 of the third embodiment can heat the image-formed recording medium p, which contains the moisture in the ink, with being always sucked on the carrying belt 107.

Here, in the ink jet head 115C, since the plural heads 600 are differently disposed from each other with respect to the carrying direction of the recording medium p, the timings when the aqueous C inks ejected from the nozzles 500 are landed on the recording medium p become different according to the positions of the heads 600 even though the inks are landed on one line in the width direction of the same recording medium p. That is, times for permeating the recording medium p by the aqueous C ink also become different. In this recording medium p, when the one line in the width direction is dried at the same time, drying marks occur.

In the third embodiment, all relative distances between the heat elements 141 and the heads 600 along the sub-scan direction, which are in facing relation therebetween, are constant. For this reason, the period of time from landing the aqueous C ink on the recording medium p ejected from the nozzles 500 until the heat elements 141 begin to heat is always constant independently from the position of the heads 600.

Therefore, in the heat-fixing device 140, the drying marks on the recording medium p are prevented, and further the heat-fixing device 140 can evaporate the moisture while the cockling in the recording medium p is corrected to be flattened. There is no cockling in the recording medium p which is passed over the heat-fixing device 140, and the ink formed as the image is also dried.

An effect of heating the recording medium p from the opposite surface of the image forming surface by the heat-fixing device 140 is the same as the effect described in the first embodiment.

Next, a modified example of the heat-fixing device 140 of the third embodiment will be described. FIG. 13 is a top view illustrating the ink jet head 115C and the heat-fixing device 140. The same is true in the above-mentioned description except for the alignments of the heads 600 and the heat elements 141.

The ink jet head 115C includes the plural heads 600 having a rectangular shape. Here, the ink jet head 115C which includes five heats 600 will be described. The plural heads 600 are disposed so as to be constantly inclined with respect to the carrying direction of the recording medium p. The plural heads 600 have a positional relation in which they are shifted on the same axis along the main scan direction. Therefore, similar to the inclination of the heads 600, the nozzles 500 which are arranged in the heads 600 are also disposed so as to be constantly inclined with respect to the carrying direction of the recording medium p.

In the heat-fixing device 140, the plural heat elements 141 are disposed so as to be the same inclination as that of the nozzles 500 with respect to the carrying direction of the recording medium p. The plural heat elements 141 have a positional relation in which they are shifted on the same axis along the main scan direction. Here, the number of the plural heat elements 141 is the same as that of the plural heads 600 which are included in the ink jet head 115C. Therefore, the number of the plural heat elements 141 is five.

The plural heat elements 141 are provided on a position facing the heads 600 which is included in the ink jet head 115C along the sub-scan direction. All relative distances along the sub-scan direction between the heat elements 141 and the heads 600, which are in facing relation therebetween, are constant. That is, if the alignments of the nozzles 500 of the heads 600 which are included in the ink jet head 115C are shifted along the sub-scan direction, the alignments are included in the alignments of the plural heat elements 141. Therefore, the heat-fixing device 140 can heat an exact portion of the recording medium p on which the image is formed.

In addition, the plural heat elements 141 are disposed so as not to come into contact with each other at a predetermined interval such that at least a portion where the heat element 141 is not disposed along the main scan direction exists. Therefore, the heat-fixing apparatus 140 can heat the image-formed recording medium p, which contains the moisture in the ink, with being always sucked on the carrying belt 107.

The configuration shown in FIG. 13 is the same as that shown in FIG. 12, and all relative distances along the sub-scan direction between the heat elements 141 and the heads 600, which are in facing relation therebetween, are constant. For this reason, the period of time from landing the aqueous C ink on the recording medium p ejected from the nozzles 500 until the heat elements 141 begin to heat is always constant independently from the position of the heads 600.

Therefore, in the heat-fixing device 140, the drying marks on the recording medium p are prevented, and further the heat-fixing device 140 can evaporate the moisture while the cockling in the recording medium p is corrected to be flattened. There is no cockling in the recording medium p which is passed over the heat-fixing device 140, and the ink formed as the image is also dried.

With the configurations of the first embodiment, the second embodiment, and the third embodiment, it is possible to perform the printing while drying the recording medium p at high speed.

What is claimed is:

1. An ink jet recording apparatus comprising:
an ink jet head in which a plurality of nozzles is arranged;
a sub-scan driving unit which carries a recording medium to be formed with an image;
a suction unit which sucks the recording medium on the sub-scan driving unit; and
a heating unit which is disposed with respect to at least one place of the sub-scan driving unit in a direction perpendicular to a carrying direction of the recording medium with a gap therebetween.

2. The apparatus of claim 1, wherein the sub-scan driving unit comes into contact with a lower surface of the recording medium and an upper surface of the recording medium is opened.

3. The apparatus of claim 1, wherein the sub-scan driving unit is provided with a plurality of openings which are formed as paths of airflow to suck the recording medium by the suction unit from a lower side of the sub-scan driving unit.

4. The apparatus of claim 1, wherein the heating unit is provided on a downstream side of the ink jet head along a carrying direction of the recording medium.

5. The apparatus of claim 1, wherein an alignment direction of the plurality of the nozzles is perpendicular to a carrying direction of the recording medium by the sub-scan driving unit.

6. The apparatus of claim 1, wherein the heating unit heats the image-formed recording medium from an opposite side of an image forming surface.

7. The apparatus of claim 1, wherein the heating unit includes a plurality of heat elements which are differently disposed from each other with respect to a carrying direction of the recording medium.

8. The apparatus of claim 1, wherein the heating unit includes a plurality of heat elements which is disposed so as to be inclined with respect to a carrying direction of the recording medium.

9. The apparatus of claim 1, wherein if the ink jet head includes a first color ink jet head and a second color ink jet head along a carrying direction of the recording medium, the heating units are provided at a position between the first color ink jet head and the second color ink jet head along a carrying direction of the recording medium and a position of a downstream side of the second color ink jet head, respectively.

10. The apparatus of claim 9, wherein an alignment direction of the plurality of the nozzles is perpendicular to a carrying direction of the recording medium by the sub-scan driving unit.

11. The apparatus of claim 10, wherein the heating unit includes a plurality of heat elements which are differently disposed from each other with respect to a carrying direction of the recording medium.

12. The apparatus of claim 10, wherein the heating unit includes a plurality of heat elements which are disposed so as to be inclined with respect to a carrying direction of the recording medium.

13. The apparatus of claim 1, wherein the heating unit includes a plurality of heat elements which have the same alignment as that of the plurality of the nozzles.

14. The apparatus of claim 13, wherein the ink jet head is provided so as to be divided into plural ones in a direction perpendicular to a carrying direction of the recording medium.

15. The apparatus of claim 14, wherein an alignment direction of a plurality of nozzles of each divided ink jet head and an alignment direction of the plurality of the heat elements are perpendicular to a carrying direction of the recording medium.

16. The apparatus of claim 15, wherein the divided ink jet heads and the plurality of the heat elements are differently disposed from each other with respect to a carrying direction of the recording medium.

17. The apparatus of claim 14, wherein an alignment direction of a plurality of nozzles of each divided ink jet head and an alignment direction of the plurality of the heat elements are inclined with respect to a carrying direction of the recording medium.

18. The apparatus of claim 17, wherein all relative distances between the heat elements and the divided ink jet heats, which are in facing relation therebetween along the carrying direction of the recording medium, are constant.

19. A method of drying ink comprising:
forming an image with respect to a recording medium by using an ink ejected from a nozzle of an ink jet head;
placing and carrying the recording medium on a belt during the image forming;
heating the recording medium from a lower side of the belt in a direction perpendicular to a carrying direction of the recording medium; and
when the recording medium is heated, sucking at least one place of the recording medium which is in a direction perpendicular to the carrying direction of the belt.

20. An ink jet recording apparatus comprising:
means for discharging an ink from an ink jet head on which a plurality of nozzles are arranged;
means for carrying a recording medium to be formed with an image;
means for sucking the recording medium to be carried;
means for heating the recording medium, of which at least one place is separated at a distance in a direction perpendicular to a carrying direction of the recording medium with a gap therebetween.
